(19) United States
(12) Patent Application Publication
(10) Pub. No.: US 2025/0200710 A1
(43) Pub. Date: Jun. 19, 2025

(54) CAMERA TRANSITION FOR IMAGE CAPTURE DEVICES WITH VARIABLE APERTURE CAPABILITY

(71) Applicant: QUALCOMM Incorporated, San Diego, CA (US)

(72) Inventors: Wen-Chun Feng, New Taipei City (TW); Yu-Ren Lai, Xinyi District (TW); Hsin Yueh Chang, Zhubei City (TW); Hanlu Zhu, Shanghai (CN)

(21) Appl. No.: 18/847,887

(22) PCT Filed: May 10, 2022
(86) PCT No.: PCT/CN2022/091865

§ 371 Date: Sep. 17, 2024

(51) Int. Cl. G06T 5/50; G06T 5/70; H04N 23/45; H04N 23/73; H04N 23/76

(52) U.S. Cl. CPC G06T 5/50; G06T 5/70; H04N 23/45; H04N 23/73; H04N 23/76

(57) ABSTRACT

This disclosure provides systems, methods, and devices for image capture that support image processing. In a first aspect, a method of image processing includes receiving first image data from a first image sensor; receiving second image data from a second image sensor of a second camera, wherein at least one of the first image data or the second image data is received through a variable aperture (VA) having an adjusted aperture setting applied by the first camera or the second camera; and/or determining a first output frame based on the first image data and the second image data by adjusting the second image data to match a characteristic of the first image data. Other aspects and features are also claimed and described.

### TECHNICAL FIELD

Aspects of the present disclosure relate generally to image processing, and more particularly, to processing image data for image capture devices with multiple image sensor. Some features may enable and provide improved image processing, including improved consistency when transitioning between image sensors of an image capture device.

### INTRODUCTION

Image capture devices are devices that can capture one or more digital images, whether still image for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

Image sensors on image capture devices are components that include an array of detectors configured to generate electrical signals proportional to an amount of light received by the detectors. The image sensor may have a color filter array matched to the array of detectors, such that each detector measures the intensity of light of an individual color, which in some configurations may be intensities of red, blue, and green. A lens associated with the image sensor directs light to the image sensor. The lens is characterized by an aperture size, sometimes referred to as an f-stop, which defines a size of a diaphragm through which the light is directed to the image sensor. A larger aperture size, denoted by a smaller f-stop, allows more light to be captured by the image sensor, which, for example, increases image quality in dark settings. A smaller aperture size, denoted by a larger f-stop, allows less light to be captured, which, for example, increases depth of focus (DOF) and increases an amount of a scene that is in focus.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

An image capture device may include more than one image sensor to support different types of photography, such as portrait, night, landscape, and each of those image sensors may have a different associated lens system with different aperture sizes. In some aspects, one or more of the image sensors may have a variable aperture (VA) lens system may be configured for use with an image sensor. The VA lens system allows the aperture size to be changed during operation of the image capture device, which provides the image capture device or the user with control over a brightness of a captured photography and control over a depth of focus (DOF) of a captured photograph.

Variable aperture camera modules can provide for improved quality in low-light scenes and can provide for natural bokeh effects by allowing the user to configure the camera to different aperture sizes, which receive different amounts of light with different bokeh amounts. However, different aperture settings applied by the same camera will result in differences in texture/noise and DOF. Further, other cameras of an image capture device may have a non-variable aperture (non-VA), which may result in an abrupt change in the form of noticeable DOF transitions when switching between cameras. Embodiments disclosed herein may apply image processing to transition cameras while providing DOF consistency near camera transitions by applying a blur to background areas in non-VA image data when transitioning from a VA camera to a non-VA camera, and by setting the aperture of a VA camera to mirror the DOF of the non-VA camera when transitioning from a non-VA camera to a VA camera. Through one or a combination of techniques described in embodiments herein, DOF may appears more consistent when switching cameras.

In one aspect of the disclosure, a method for image processing includes receiving first image data from a first image sensor of a first camera; receiving second image data from a second image sensor of a second camera, wherein at least one of the first image data or the second image data is received through a variable aperture (VA) having an adjusted aperture setting applied by the first camera or the second camera; determining a first output frame based on the first image data and the second image data by adjusting the second image data to match a characteristic of the first image data.

In an additional aspect of the disclosure, an apparatus includes at least one processor and a memory coupled to the at least one processor. The at least one processor is configured to perform operations including receiving first image data from a first image sensor of a first camera; receiving second image data from a second image sensor of a second camera, wherein at least one of the first image data or the second image data is received through a variable aperture (VA) having an adjusted aperture setting applied by the first camera or the second camera; and/or determining a first output frame based on the first image data and the second image data by adjusting the second image data to match a characteristic of the first image data.

In an additional aspect of the disclosure, an apparatus includes a first camera comprising a first image sensor; a second camera comprising a second image sensor; a variable aperture, wherein the variable aperture is included in one of the first camera or the second camera; and at least one processor coupled to the first camera and to the second camera and a memory coupled to the at least one processor, with the at least one processor configured to perform operations including receiving first image data from a first image sensor of a first camera; receiving second image data from a second image sensor of a second camera, wherein at least one of the first image data or the second image data is received through a variable aperture (VA) having an adjusted aperture setting applied by the first camera or the second camera; and/or determining a first output frame based on the first image data and the second image data by adjusting the second image data to match a characteristic of the first image data.

In an additional aspect of the disclosure, an apparatus includes means for receiving first image data from a first image sensor of a first camera; means for receiving second image data from a second image sensor of a second camera, wherein at least one of the first image data or the second image data is received through a variable aperture (VA) having an adjusted aperture setting applied by the first camera or the second camera; and/or means for determining a first output frame based on the first image data and the second image data by adjusting the second image data to match a characteristic of the first image data.

In an additional aspect of the disclosure, a non-transitory computer-readable medium stores instructions that, when executed by a processor, cause the processor to perform operations. The operations include receiving first image data from a first image sensor of a first camera; receiving second image data from a second image sensor of a second camera, wherein at least one of the first image data or the second image data is received through a variable aperture (VA) having an adjusted aperture setting applied by the first camera or the second camera; and/or determining a first output frame based on the first image data and the second image data by adjusting the second image data to match a characteristic of the first image data.

Image capture devices, devices that can capture one or more digital images whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

In general, this disclosure describes image processing techniques involving digital cameras having image sensors and image signal processors (ISPs). The ISP may be configured to control the capture of image frames from one or more image sensors and process one or more image frames from the one or more image sensors to generate a view of a scene in a corrected image frame. A corrected image frame may be part of a sequence of image frames forming a video sequence. The video sequence may include other image frames received from the image sensor or other images sensors and/or other corrected image frames based on input from the image sensor or another image sensor. In some embodiments, the processing of one or more image frames may be performed within the image sensor, such as in a binning module. The image processing techniques described in embodiments disclosed herein may be performed by circuitry, such as a binning module, in the image sensor, in the image signal processor (ISP), in the application processor (AP), or a combination or two or all of these components.

In an example, the image signal processor may receive an instruction to capture a sequence of image frames in response to the loading of software, such as a camera application, to produce a preview display from the image capture device. The image signal processor may be configured to produce a single flow of output frames, based on images frames received from one or more image sensors. The single flow of output frames may include raw image data from an image sensor, binned image data from an image sensor, or corrected image frames processed by one or more algorithms, such as in a binning module, within the image signal processor. For example, an image frame obtained from an image sensor, which may have performed some processing on the data before output to the image signal processor may be processed in the image signal processor by processing the image frame through an image post-processing engine (IPE) and/or other image processing circuitry for performing one or more of tone mapping, portrait lighting, contrast enhancement, gamma correction, etc.

After an output frame representing the scene is determined by the image signal processor using the image correction, such as binning described in various embodiments herein, the output frame may be displayed on a device display as a single still image and/or as part of a video sequence, saved to a storage device as a picture or a video sequence, transmitted over a network, and/or printed to an output medium. For example, the image signal processor may be configured to obtain input frames of image data (e.g., pixel values) from the different image sensors, and in turn, produce corresponding output frames of image data (e.g., preview display frames, still-image captures, frames for video, frames for object tracking, etc.). In other examples, the image signal processor may output frames of the image data to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. That is, the image signal processor may obtain incoming frames from one or more image sensors, each coupled to one or more camera lenses, and, in turn, may produce and output a flow of output frames to various output destinations.

In some aspects, the corrected image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The apparatus may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur with a lens cluster on a mobile device, such as where multiple image sensors and associated lenses are located in offset locations on a frontside or a backside of the mobile device. Additional image sensors may be included with larger, smaller, or same field of views. The image correction techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in as a recording or as streaming data, over a first network connection of a plurality of network connections; and a processor coupled to the first network adaptor, and the memory. The processor may cause the transmission of corrected image frames described herein over a wireless communications network such as a 5G NR communication network.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device 100 for performing image capture from one or more image sensors.

FIG. 2A is an illustration of a process for switching from a VA camera to a non-VA camera according to some embodiments of the disclosure.

FIG. 2B is an illustration of a process for switching from a non-VA camera to a VA camera according to some embodiments of the disclosure.

FIG. 3 is a block diagram illustrating an image processing technique for transitioning between non-VA and VA cameras according to some embodiments of the disclosure.

FIG. 4 is a flow chart illustrating a method of processing image data during a transition between non-VA and VA cameras according to some embodiments of the disclosure.

FIG. 5 is a flow chart illustrating an example method of processing image data during a transition from a VA camera to a non-VA camera according to some embodiments of the disclosure.

FIG. 6 is a flow chart illustrating an example method of processing image data during a transition from a non-VA camera to a VA camera according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing for camera transitioning, including from a variable aperture (VA) camera to a non-VA camera and from a non-VA camera to a VA camera.

Particular implementations of the subject matter described in this disclosure may be implemented to realize one or more of the following potential advantages or benefits. In some aspects, the present disclosure provides techniques for improving a user experience operating an image capture device with multiple image sensors. Embodiments of this disclosure may be applied to conceal a sudden change in image appearance during operation of an image capture device. Transitioning from one image sensor to another image sensor can be smoothed to reduce abruptness in a sequence of image frames generated by the image capture device. The transitioning may be particularly advantageous in embodiments in which one or more of the image sensors is configured in a VA camera for variable aperture (VA) operation, because the VA camera can be adjusted as part of the transition. For smooth transitions, the aperture size of the VA camera may be decided in advance according to a particular scene detected in the image data and/or changed before camera switching time based on matching characteristics of an aperture size of a non-VA camera. Matching may refer to having characteristics more like the aperture size of the non-VA camera, which does not require a perfect match. Characteristics may be matched when the matching results in characteristics similar to that of the non-VA camera, such as having an image brightness approximately the same and/or having an image brightness similarity such that the image differences are unnoticeable to a user.

An example device for capturing image frames using one or more image sensors, such as a smartphone, may include a configuration of two, three, four, or more cameras on a backside (e.g., a side opposite a user display) or a front side (e.g., a same side as a user display) of the device. One or more of the image sensors may be configured for variable aperture (VA) operation, such as with a variable aperture element coupled to the image sensor as part of a camera module. Devices with multiple image sensors include one or more image signal processors (ISPs), Computer Vision Processors (CVPs) (e.g., AI engines), or other suitable circuitry for processing images captured by the image sensors. The one or more image signal processors may provide processed image frames to a memory and/or a processor (such as an application processor, an image front end (IFE), an image processing engine (IPE), or other suitable processing circuitry) for further processing, such as for encoding, storage, transmission, or other manipulation.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including or coupled to two or more image sensors capable of capturing image frames (or “frames”). Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

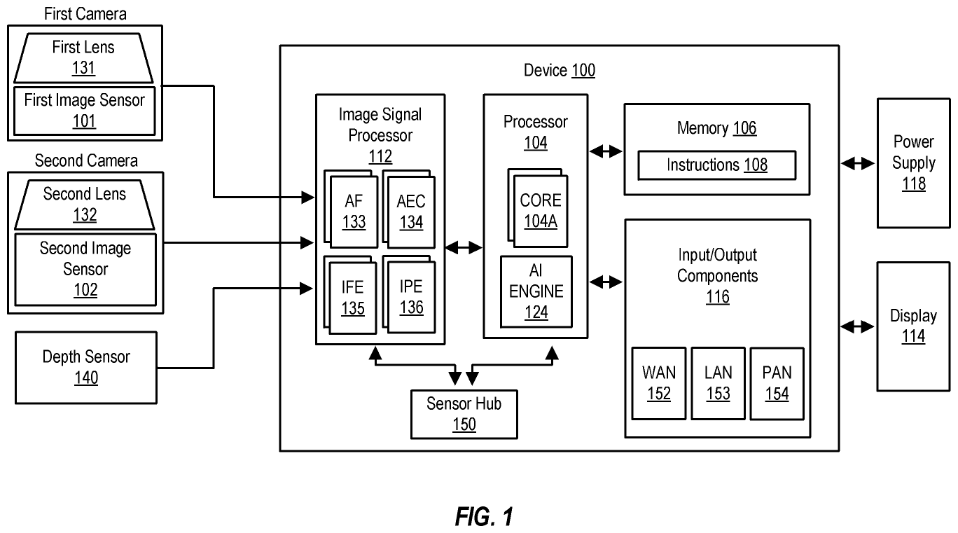

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is a IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first and second camera, respectively. In another embodiment, a wire interface couples the image signal processor 112 to an external image sensor. In a further embodiment, a wireless interface couples the image signal processor 112 to the image sensor 101, 102.

The first camera may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors. That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112 and output from the depth sensors processed in a similar manner to that of image sensors 101 and 102. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), and or one or more auto exposure compensation (AEC) 134 engines. The AF 133, AEC 134, AFE 135, APE 136 may each include application-specific circuitry, be embodied as software code executed by the ISP 112, and/or a combination of hardware within and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including noise reduction operations. For example, execution of the instructions can instruct the image signal processor 112 to begin or end capturing an image frame or a sequence of image frames, in which the capture includes noise reduction as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, the camera application may receive a command to begin a video preview display upon which a video comprising a sequence of image frames is captured and processed from one or more image sensors 101 or 102. Image correction, such as with cascaded IPEs, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124) in addition to the ability to execute software to cause the device 100 to perform a number of functions or operations, such as the operations described herein. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

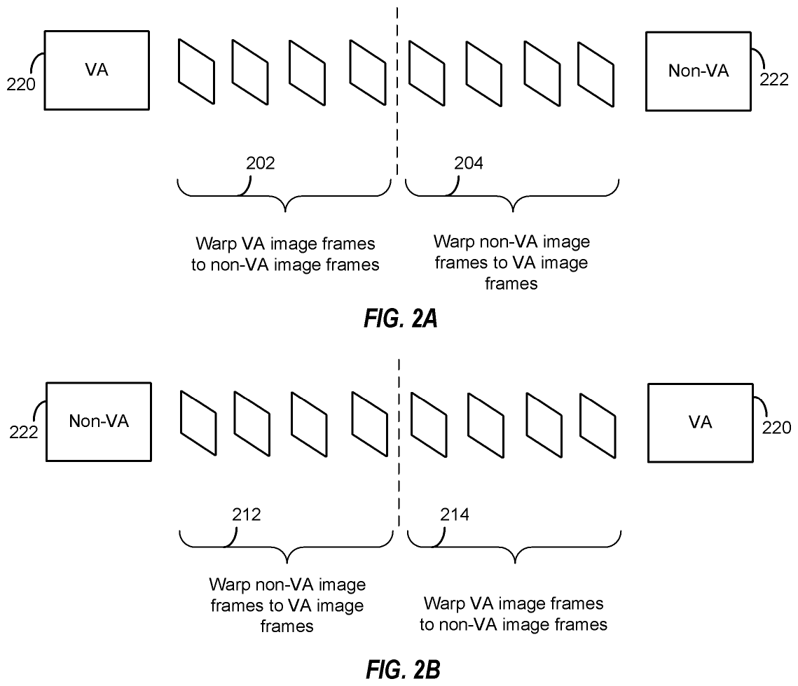

In some embodiments of an image capture device, the first camera and/or second camera may support variable aperture (VA) operation, allowing the aperture to vary during the capture of image data. When one camera is configured for VA operation and another camera does not support VA operation there may be an abrupt change when switching image capture operations between the VA and non-VA cameras. For example, there may be brightness, texture, noise, and depth of focus (DOF) differences between the same image scene captured by the VA camera and the non-VA camera. Image processing may be performed to smooth the transition between the VA and non-VA camera, or vice versa, such that the abruptness or artefacts in the user's preview image from the image capture device, the user's recorded video, the user's recorded photograph sequence, and/or other outputs of image frames from the image capture device. FIGS. 2A and 2B illustrate example image processing for transitioning between VA to non-VA and non-VA to VA cameras, respectively.

FIG. 2A is an illustration of a process for switching from a VA camera to a non-VA camera according to some embodiments of the disclosure. For example, a VA camera 220 may generate image data for forming output image frames for display on a display of the image capture device. A transition to non-VA camera 222 may be determined, after which image data from both the VA camera 220 and the non-VA camera 222 are used for forming output image frames for display to the user. During time period 202, VA image frames comprising image data from the VA camera 220 are processed to match non-VA image frames comprising image data from the non-VA camera 222. Next, during time period 204, non-VA image frames comprising image data from the non-VA camera 222 are processed to match VA image frames comprising image data from the VA camera 220. During the time periods 202 and 204, processing may be performed to generate a smooth transition from displaying the image data output from VA camera 220 to displaying the image data output from non-VA camera 222. In some embodiments, the processing may include warping, which refers to the adjusting the image data of a source camera to match a field of view of image data of a target camera. The adjusting is determined in amounts over several image frames to smooth the transition between the different fields of view of the VA camera 220 and the non-VA camera 222. The processing may also include other adjustments to smooth the transition between cameras, such as background blurring, background sharpening, image brightness, texture, noise, and/or others.

In a similar manner, a process for switching from a non-VA camera to a VA camera can be performed. FIG. 2B is an illustration of a process for switching from a non-VA camera to a VA camera according to some embodiments of the disclosure. For example, a non-VA camera 222 may generate image data for forming output image frames for display on a display of the image capture device. A transition to VA camera 220 may be determined, after which image data from both the non-VA camera 222 and the VA camera 220 are used for forming output image frames for display to the user. During time period 212, non-VA image frames comprising image data from the non-VA camera 222 are processed to match VA image frames comprising image data from the VA camera 220. Next, during time period 214, VA image frames comprising image data from the VA camera 220 are processed to match non-VA image frames comprising image data from the non-VA camera 222. During the time periods 212 and 214, processing may be performed to generate a smooth transition from displaying the image data output from non-VA camera 222 to displaying the image data output from VA camera 220.

In some embodiments, the transition from a non-VA camera to a VA camera or a VA camera to a non-VA camera may include adjusting an aperture size of the VA camera. For example, when transitioning from a non-VA camera to a VA camera as in FIG. 2B, the aperture size of the VA camera may be adjusted during a portion of time period 212 to decrease a difference in aperture size between the non-VA camera 222 and the VA camera 220. During time period 214 and/or after time period 214, the VA camera 220 may adjust aperture size based on scene conditions, user input, or other criteria apart without being based on an aperture size of the non-VA camera 222. Likewise, when transitioning from a VA camera to a non-VA camera as in FIG. 2A, the aperture size of the VA camera may be adjusted during a portion of time period 202 to decrease a difference in aperture size between the VA camera 220 and the non-VA camera 222.

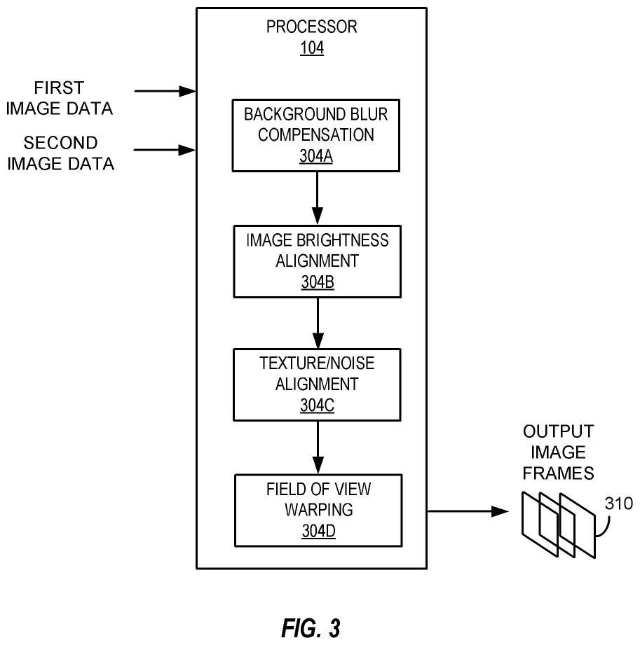

The adjusting of one image data captured from one camera to match characteristics of other image data may be performed by the processor 104 of an image capture device. One example of such a configuration for a processor is shown in FIG. 3, although other logic circuitry may be similarly configured to process the image data, such as the IFE 135 of ISP 112.

FIG. 3 is a block diagram illustrating an image processing technique for transitioning between non-VA and VA cameras according to some embodiments of the disclosure. A processor 104 may receive first image data, such as image data from a VA camera, and second image data, such as image data from a non-VA camera. After processing the first and second image data, the processor 104 may generate output image frames 310. In some embodiments, the output image frames 310 may be displayed on a display through a preview application executing on the image capture device. In some embodiments, the output image frames 310 may be output to a video file. In some embodiments, the output image frames 310 may be transmitted to a remote location through a network, such as a wireless communications link, for display or storage at another location from the location of the image capture device. In some embodiments, the output image frames 310 may be directed to multiple uses and/or locations, and/or further processed beyond the processing shown in FIG. 3.

The processing of the first and second image data may including processing through one or more modules 304A, 304B, 304C, and/or 304D. For example, processing may be performed in background blur compensation module 304A. The background blur compensation module 304A may process first image data to match a background blur of second image data. When the first and second image data are obtained from different camera with different aperture sizes, the depth of focus (DOF) of the image data is different, resulting in a different amount of background blur in the scene as represented in the first and second image data. Because larger aperture sizes lead to shallow DOF in the background, when switching to smaller aperture size, background blurring may be added to the image data acquired from the smaller aperture size to match the DOF of the larger aperture size. Then, the amount of background blurring is decreased until the camera transition is determined to be completed, and the output image frames are generated based only on the image data from the camera with the smaller aperture size. Likewise, when switching from a camera with a smaller aperture size to a camera with a larger aperture size, the background blur may be increased gradually in subsequent frames of the output image frames 310 through the transition, until the output image frames are generated based only on image data from the camera with the larger aperture size.

As another example, processing may be performed in image brightness alignment module 304B. The image brightness alignment module 304B may process second image data to match an image brightness of first image data. Because a larger aperture can result in a brighter image, the average brightness of the second image data can be increased when switching from a camera with larger aperture size to smaller aperture size. Then, the amount of image brightness increase may be gradually decreased to align the brightness with the smaller aperture of the first image data. For example, the brightness may be adjusted by increasing a gain of the second camera to match the first camera, and gradually decreasing the gain. After the transition is complete, the gain of the second camera may be automatically adjusted based on scene conditions without regard to the brightness of the first camera. Likewise, when switching from a camera with a smaller aperture size to a camera with a larger aperture size, gain may be decreased to reduce image brightness in the second image data to match an image brightness of the first image data until the output image frames are generated based only on image data from the camera with the larger aperture size.

As a further example, processing may be performed in texture/noise alignment module 304C. The texture/noise alignment module 304C may process second image data to match a texture or noise characteristic of first image data. Because image captured by a larger aperture may have higher acutance but worse noise level, processing of the second image data may include adjusting a sharpness and/or adjusting an impulse noise on the first image data acquired from a camera with a smaller aperture size. Then, the applied sharpness and/or noise degree may be adjusted over time to fit the camera corresponding to the first image data. Likewise, when switching from a smaller aperture size to a larger aperture size, the processing may increasingly apply sharpness and/or noise degree to smooth a transition to the larger aperture size.

As another example, processing may be performed in field of view warping module 304D. The warping module 304D may process second image data to match a field of view of first image data. Image data captured by two different cameras at different locations may have different field of views. Further, misalignment during manufacturing may further shift the field of view. Still further, different zoom levels between two cameras may result in still further different field of views. Processing of the second image data may include warping by cropping, compositing, or otherwise adjusting the second image data to match a field of view of the first image data. The amount of this warping may be decreased through a sequence of image frames util output image frames are generated based on image data only from the second camera and the output image frames have a field of view corresponding to the location, zoom level, and other characteristics of the second camera.

In some embodiments, the processor 104 may have a configuration record indicating a configuration of the first camera from which the first image data is acquired and of the second camera from which the second image data is acquired. For example, the configuration record may indicate an aperture size, image sensor type, or other information from which the processor 104 may use to determine an amount to adjust a characteristic of the second image data to match the same characteristic of the first image data. In the background blur compensation module 304A, the processor 104 may use a first aperture size of the first camera acquiring the first image data and a second aperture size of the second camera acquiring the second image data to determine an amount of background blur to add to the second image data to match the first image data.

In some embodiments, the processor 104 may receive metadata accompanying the first image data and the second image data indicating a configuration of the first camera from which the first image data is acquired and of the second camera from which the second image data is acquired. For example, first meta data may indicate an aperture size, image sensor type, or other information from which the processor 104 may use to determine an amount to adjust a characteristic of the second image to match the same characteristic of the first image data. In the background blur compensation module 304A, the processor 104 may use a first aperture size of the first camera acquiring the first image data and a second aperture size of the second camera acquiring the second image data to determine an amount of background blur to add to the second image data to match the first image data.

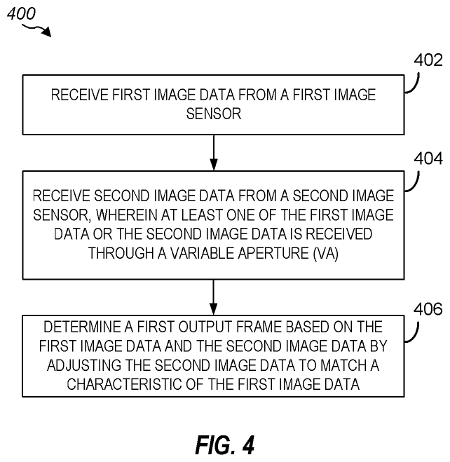

A method according to some of the embodiments described herein is shown in FIG. 4. FIG. 4 is a flow chart illustrating a method of processing image data during a transition between non-VA and VA cameras according to some embodiments of the disclosure. A method 400 includes, at block 402, receiving first image data from a first image sensor. The processor 104 may receive first image data from a first camera with a first image sensor 101 through image signal processor 112 and/or memory 106.

At block 404, second image data is received from a second image sensor, in which at least one of the first image data or the second image data is received through a variable aperture. The variable aperture may be part of a camera comprising a corresponding one of the first image sensor or the second image sensor, and, in some embodiments, additional camera components such as a lens. The variable aperture may be any component capable of reducing the actual or effective aperture size of the image data captured by the corresponding image sensor, such as a set of adjustable blades or a shutter. The variable aperture may be controlled between different aperture sizes according to an adjusted aperture setting that is applied by the camera, which may be controlled by a component external to the camera such as the image signal processor 112. An image sensor coupled to the variable aperture for receiving light representative of a scene through the variable aperture may be considered to be an image sensor configured with variable aperture (VA) operation. The processor 104 may receive second image data from a second camera with a second image sensor 102 through image signal processor 112 and/or memory 106.

At block 406, a first output image frame is determined based on the first image data and the second image data by adjusting the second image data to match a characteristic of the first image data. The processing of block 406 may be performed, for example, by a processor 104 configured, at least in part, as shown in FIG. 3. For example, adjusting the second image data may include adjusting the second image data to match a depth of focus (DOF) of the first image data. As another example, adjusting the second image data may include warping the second image data to match a field of view (FOV) of the first image data. As a further example, adjusting the second image data may include adjusting the second image data to match an image brightness of the first image data.

In some embodiments, the method 400 may be initiated for transitioning from the first camera to the second camera. For example, before block 406, the method 400 may include determining to switch from the first image sensor to the second image sensor before determining the first output frame of block 406. After determining a first output image frame, the method may continue to process image data to change the amount of adjustment such that a smooth transition from the characteristic of the first camera to the characteristic of the second camera is obtained in the output image frames. For example, the method 400 may further include receiving third image data from the first image sensor and receiving fourth image data from the second image sensor, which may be used in determining a first plurality of output frames based on the third image data and the fourth image data for transitioning between a VA image sensor and a non-VA image sensor. After the transition is determined to be complete, the method 400 may continue with processing additional image data from the second camera to determine output image frames, such as by receiving fifth image data from the second image sensor and determining a second plurality of output frames based on the fifth image data without reference to image data from the first image sensor.

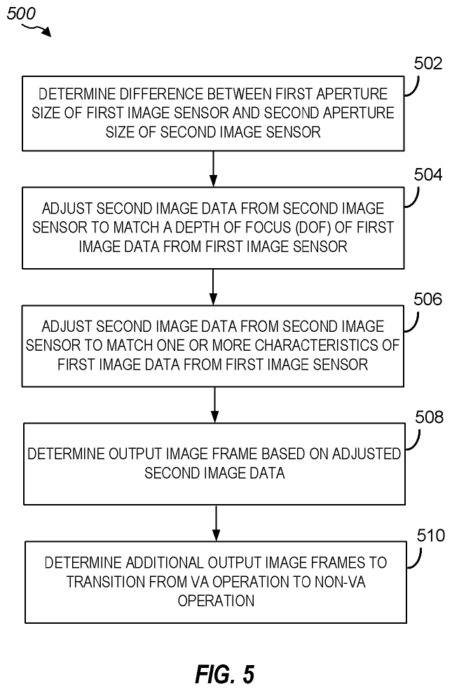

Additional details for embodiments of processing when transitioning from a VA camera to a non-VA camera are described with reference to FIG. 5. FIG. 5 is a flow chart illustrating an example method of processing image data during a transition from a VA camera to a non-VA camera according to some embodiments of the disclosure. In the operation of FIG. 5, a master camera is the VA camera and a slave camera is the non-VA camera. A method 500 may include at block 502, determining a difference between a first aperture size of the first image sensor and a second aperture size of the second image sensor. For example, a processor may determine a difference of texture, noise, and/or depth of focus between two aperture sizes. The determination may include estimating relationships of texture/noise level and blur degree by extracted gradient comparison between the two aperture sizes. The gradient may be used to determine the noise level and/or texture level, which may be used as a measure of the clarity and sharpness of the image data. The relationship of gradient between the two image data may be used to determine an amount of matching to apply to the second image data when transitioning from the first camera to the second camera.

At block 504, the second image data is adjusted to match a depth of focus (DOF), and possibly other characteristics at block 506, of the first image data. The adjusting of blocks 504 and 506 may be applied to each image frame acquired from the first image sensor and the second image sensor while the transition is performed. An output image frame may be determined at block 508 based on the adjusted second image data, in which the output image frame is based on both the first image data and the second image data because the adjustment of blocks 504 and 506 are based on the first image data. At block 510, the method 500 continues with determining additional output image frames to transition from VA operation to non-VA operation, such as by gradually reducing the amount of adjustment at blocks 504 and 506 to reach a time when second image data is not adjusted based on the first image data.

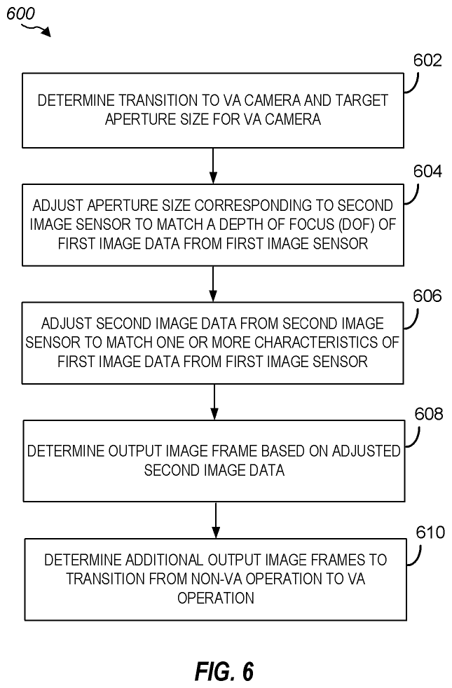

Additional details for embodiments of processing when transitioning from a non-VA camera to a VA camera are described with reference to FIG. 6. FIG. 6 is a flow chart illustrating an example method of processing image data during a transition from a non-VA camera to a VA camera according to some embodiments of the disclosure. In the operation of FIG. 6, a slave camera is the VA camera and a master camera is the non-VA camera. A method 600 includes at block 602 determining to transition to a VA camera and a target aperture size for the VA camera. Block 602 may include detecting a scene type, such as through a scene detection algorithm based on AEC lux index and/or depth info and environmental models to determine conditions such as a lowlight scene, a multi-depth scene, or an infinite scene. For example, when a lowlight scene is detected, a larger aperture size for the VA camera than the current non-VA camera may be set as a target aperture size. As another example, when a multi-depth scene is detected, a smaller aperture size for the VA camera than the current non-VA camera may be set as a target aperture size. As a further example, when an infinite scene is detected, a smaller aperture size for the VA camera than the current non-VA camera may be set as a target aperture size when first criteria are satisfied, such as a preference for better corner acutance. Otherwise, a larger aperture size for the VA camera than the current non-VA camera may be set as a target aperture size when second criteria are satisfied, such as no preference for better corner acutance.

The transition may then be initiated and output image frames determined based on first image data and second image data. At block 604, the VA camera is adjusted to match the target aperture size determined at block 602. At block 606, second image data from the VA camera is adjusted to match one or more characteristics of first image data from the non-VA camera. At block 608, an output image frame is determined based on the adjusted second image data. In some embodiments, the VA camera configuration of block 604 may be performed during generation of output image frames according to blocks 606 and 608. Additional output image frames may be determined to transition from non-VA operation to VA operation, until output image frames are generated based only on the second image data of the VA camera.

In one or more aspects, techniques for supporting image capture and/or image processing may include additional aspects, such as any single aspect or any combination of aspects described below or in connection with one or more other processes or devices described elsewhere herein. In a first aspect, supporting image capture may include an apparatus configured to capture scenes through multiple camera, one or more of which may have a variable aperture. The apparatus is further configured to perform operations including receiving first image data from a first image sensor of a first camera; receiving second image data from a second image sensor of a second camera, wherein at least one of the first image data or the second image data is received through a variable aperture (VA) having an adjusted aperture setting applied by the first camera or the second camera; and determining a first output frame based on the first image data and the second image data by adjusting the second image data to match a characteristic of the first image data.

Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication of image data (including photographs and/or videos) may include one or more operations described herein with reference to the apparatus.

In a second aspect, in combination with the first aspect, adjusting the second image data comprises adjusting the second image data to match a depth of focus (DOF) of the first image data.

In a third aspect, in combination with one or more of the first aspect or the second aspect, adjusting the second image data further comprises warping the second image data to match a field of view (FOV) of the first image data.

In a fourth aspect, in combination with one or more of the first aspect through the third aspect, the apparatus may also be configured for determining to switch from the first image sensor to the second image sensor before determining the first output frame.

In a fifth aspect, in combination with one or more of the first aspect through the fourth aspect, the apparatus may also be configured for, after determining the first output frame, receiving third image data from the first image sensor, receiving fourth image data from the second image sensor, determining a first plurality of output frames based on the third image data and the fourth image data for transitioning between a VA camera and a non-VA camera, receiving fifth image data from the second image sensor, and determining a second plurality of output frames based on the fifth image data.

In a sixth aspect, in combination with one or more of the first aspect through the fifth aspect, the apparatus may also be configured for, before determining the first output frame, determining to switch from the first image sensor to the second image sensor, wherein the first camera comprises the variable aperture (VA), wherein adjusting the second image data comprises adjusting the second image data to match a background blur of the first image data.

In a seventh aspect, in combination with one or more of the first aspect through the sixth aspect, the adjusting the second image data comprises adjusting the second image data to match a depth of focus (DOF) of the first image data.

In an eighth aspect, in combination with one or more of the first aspect through the seventh aspect, the adjusting the second image data further comprises adjusting the second image data to match an image brightness of the first image data.

In a ninth aspect, in combination with one or more of the first aspect through the eighth aspect, the apparatus may also be configured for, before determining the first output frame, determining to switch from the first image sensor to the second image sensor, wherein the second camera comprises the variable aperture (VA), and adjusting a second aperture size of the second camera to match a first aperture size of the first camera.

In a tenth aspect, in combination with one or more of the first aspect through the ninth aspect, the adjusting the second image data comprises adjusting the second image data to match a depth of focus (DOF) of the first image data.

In an eleventh aspect, in combination with one or more of the first aspect through the tenth aspect, the adjusting the second image data further comprises adjusting the second image data to match an image brightness of the first image data.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-6 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” (or “approximately”) may be substituted with “within [a percentage] of” what is specified, in which the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving first image data from a first image sensor of a first camera;
receiving second image data from a second image sensor of a second camera, wherein at least one of the first image data or the second image data is received through a variable aperture having an adjusted aperture setting applied by the first camera or the second camera;
determining a first output frame based on the first image data and the second image data by adjusting the second image data to match a characteristic of the first image data.

2. The method of claim 1, wherein adjusting the second image data comprises adjusting the second image data to match a depth of focus (DOF) of the first image data.

3. The method of claim 2, wherein adjusting the second image data further comprises warping the second image data to match a field of view (FOV) of the first image data.

4. The method of claim 2, further comprising:
determining to switch from the first image sensor to the second image sensor before determining the first output frame;
after determining the first output frame:
receiving third image data from the first image sensor;
receiving fourth image data from the second image sensor;
determining a first plurality of output frames based on the third image data and the fourth image data for transitioning between a variable aperture (VA) camera and a non-variable aperture (VA) camera;
receiving fifth image data from the second image sensor; and
determining a second plurality of output frames based on the fifth image data.

5. The method of claim 1, further comprising, before determining the first output frame, determining to switch from the first image sensor to the second image sensor, wherein the first camera comprises the variable aperture, wherein adjusting the second image data comprises adjusting the second image data to match a background blur of the first image data.

6. The method of claim 5, wherein adjusting the second image data comprises adjusting the second image data to match a depth of focus (DOF) of the first image data.

7. The method of claim 6, wherein adjusting the second image data further comprises adjusting the second image data to match an image brightness of the first image data.

8. The method of claim 1, further comprising:
before determining the first output frame:
determining to switch from the first image sensor to the second image sensor, wherein the second camera comprises the variable aperture (VA); and
adjusting a second aperture size of the second camera to match a first aperture size of the first camera.

9. The method of claim 8, wherein the adjusting the second image data comprises adjusting the second image data to match a depth of focus (DOF) of the first image data.

10. The method of claim 9, wherein the adjusting the second image data further comprises adjusting the second image data to match an image brightness of the first image data.

11. An apparatus, comprising:
a first camera comprising a first image sensor;
a second camera comprising a second image sensor;
a variable aperture, wherein the variable aperture is included in one of the first camera or the second camera;
a memory storing processor-readable code; and
at least one processor coupled to the memory, to the first camera, and to the second camera, wherein the at least one processor is configured to execute the processor-readable code to cause the at least one processor to perform operations including:
receiving first image data from the first image sensor;
receiving second image data from the second image sensor, wherein at least one of the first image data or the second image data is received through the variable aperture according to an adjusted aperture setting applied by the first camera or the second camera;
determining a first output frame based on the first image data and the second image data by adjusting the second image data to match a characteristic of the first image data.

12. The apparatus of claim 11, wherein the adjusting the second image data comprises adjusting the second image data to match a depth of focus (DOF) of the first image data.

13. The apparatus of claim 12, wherein the adjusting the second image data further comprises warping the second image data to match a field of view (FOV) of the first image data.

14. The apparatus of claim 12, wherein the at least one processor is configured to perform further operations including:
determining to switch from the first camera to the second camera before determining the first output frame;
after determining the first output frame:
receiving third image data from the first image sensor;
receiving fourth image data from the second image sensor;
determining a first plurality of output frames based on the third image data and the fourth image data for transitioning between the first camera and the second camera;
receiving fifth image data from the second image sensor; and
determining a second plurality of output frames based on the fifth image data.

15. The apparatus of claim 14, wherein the at least one processor is configured to perform further operations including before determining the first output frame, determining to switch from the first camera to the second camera, wherein the first camera comprises the variable aperture (VA), wherein adjusting the second image data comprises adjusting the second image data to match a background blur of the first image data.

16. The apparatus of claim 15, wherein the adjusting the second image data comprises adjusting the second image data to match a depth of focus (DOF) of the first image data.

17. The apparatus of claim 16, wherein the adjusting the second image data further comprises adjusting the second image data to match an image brightness of the first image data.

18. The apparatus of claim 11, wherein the at least one processor is configured to perform further operations including:
before determining the first output frame:
determining to switch from the first camera to the second camera, wherein the second camera comprises the variable aperture (VA); and
adjusting a second aperture size of the second camera to match a first aperture size of the first camera.

19. The apparatus of claim 18, wherein the adjusting the second image data comprises adjusting the second image data to match a depth of focus (DOF) of the first image data.

20. The apparatus of claim 19, wherein the adjusting the second image data further comprises adjusting the second image data to match an image brightness of the first image data.

21. A non-transitory computer-readable medium storing instructions that, when executed by a processor, cause the processor to perform operations comprising:
receiving first image data from a first image sensor of a first camera;
receiving second image data from a second image sensor of a second camera, wherein at least one of the first image data or the second image data is received through a variable aperture (VA) having an adjusted aperture setting applied by the first camera or the second camera;
determining a first output frame based on the first image data and the second image data by adjusting the second image data to match a characteristic of the first image data.

22. The non-transitory, computer-readable medium of claim 21, wherein the adjusting the second image data comprises adjusting the second image data to match a depth of focus (DOF) of the first image data.

23. The non-transitory, computer-readable medium of claim 22, wherein the adjusting the second image data further comprises warping the second image data to match a field of view (FOV) of the first image data.

24. The non-transitory, computer-readable medium of claim 22, wherein the operations further include one or more operations of:
determining to switch from the first image sensor to the second image sensor before determining the first output frame;
after determining the first output frame:
receiving third image data from the first image sensor;
receiving fourth image data from the second image sensor;
determining a first plurality of output frames based on the third image data and the fourth image data for transitioning between a VA camera and a non-VA camera;
receiving fifth image data from the second image sensor; and
determining a second plurality of output frames based on the fifth image data.

25. The non-transitory, computer-readable medium of claim 21, wherein the operations further include one or more operations of:
before determining the first output frame:
determining to switch from the first image sensor to the second image sensor, wherein the second camera comprises the variable aperture (VA); and
adjusting a second aperture size of the second camera to match a first aperture size of the first camera.

26. An apparatus, comprising:
a memory storing processor-readable code; and
at least one processor coupled to the memory, the at least one processor configured to execute the processor-readable code to cause the at least one processor to:
receiving first image data from a first image sensor of a first camera;
receiving second image data from a second image sensor of a second camera, wherein at least one of the first image data or the second image data is received through a variable aperture (VA) having an adjusted aperture setting applied by the first camera or the second camera;
determining a first output frame based on the first image data and the second image data by adjusting the second image data to match a characteristic of the first image data.

27. The apparatus of claim 26, wherein the adjusting the second image data comprises adjusting the second image data to match a depth of focus (DOF) of the first image data.

28. The apparatus of claim 27, wherein the adjusting the second image data further comprises warping the second image data to match a field of view (FOV) of the first image data.

29. The apparatus of claim 27, wherein the at least one processor is configured to perform further operations including:
determining to switch from the first image sensor to the second image sensor before determining the first output frame;
after determining the first output frame:
receiving third image data from the first image sensor;
receiving fourth image data from the second image sensor;
determining a first plurality of output frames based on the third image data and the fourth image data for transitioning between a VA camera and a non-VA camera;
receiving fifth image data from the second image sensor; and
determining a second plurality of output frames based on the fifth image data.

30. The apparatus of claim 26, wherein the at least one processor is configured to perform further operations including:
before determining the first output frame:
determining to switch from the first image sensor to the second image sensor, wherein the second camera comprises the variable aperture (VA); and
adjusting a second aperture size of the second camera to match a first aperture size of the first camera.
